(19) United States
(12) Patent Application Publication
(10) Pub. No.: US 2008/0192609 A1
(43) Pub. Date: Aug. 14, 2008

(54) Data reading method

(75) Inventors: Yueh-Lin Li, Hsinchu (TW); Chia-Yen Chang, Hsinchu (TW); Cheng-Yao Liao, Hsinchu (TW)

Correspondence Address: BACON & THOMAS, PLLC, 625 SLATERS LANE, FOURTH FLOOR, ALEXANDRIA, VA, 22314, US

(73) Assignee: LITE-ON IT CORPORATION, Hsinchu (TW)

(21) Appl. No.: 12/010,672

(22) Filed: Jan. 29, 2008

(30) Foreign Application Priority Data
Feb. 13, 2007 (CN) 200710079233.5

(51) Int. Cl. G11B 7/00

(52) U.S. Cl. 369/103

(57) ABSTRACT

A data reading method used in a reading device is provided. The reading device is for reading a hologram storage medium having a plurality of data pages, wherein each data page forms a data image having a plurality of image pixels on a sensing area of the reading device. The sensing area has a plurality of sensing pixels. The data reading method first determines a relative positional relationship between each image pixel and the sensing pixels or the optical quality of the corresponding data image of each image pixel. Next, a corresponding decoding unit of the sensing area is determined according to at least one of the relative positional relationship and the optical quality. Last, each image pixel is decoded by the corresponding decoding unit.

This application claims the benefit of People's Republic of China application Serial No. 200710079233.5, filed Feb. 13, 2007, the subject matter of which is incorporated herein by reference.

### BACKGROUND OF THE INVENTION

1. Field of the Invention

The invention relates in general to a hologram storage technology, and more particularly to a data reading method for adjusting the size of the decoding unit appropriately.

2. Description of the Related Art

Hologram storage technology mainly uses a spatial light modulator (SLM) to convert digital data into signal light composed by bright spots and dark spots in a two-dimensional arrangement. Then, the signal light and a reference light form an interference pattern (a hologram also called a data page) representing the original data, then the interference pattern is recorded in the storage medium such as optical disc. Besides, a plurality of data pages can be stacked tightly and recorded in the same area (the data area) of the storage medium by ways of various recording methods such as angle multiplexing, wavelength division multiplexing, random phase multiplexing, shift multiplexing and orthogonal phase multiplexing, and so on. When reading data, the reference light complying with a certain parameter is emitted onto the data area, then the signal light corresponding to a particular data page of the data area is reproduced. At last, the signal light is retrieved and decoded by a light sensing device to obtain the original digital data.

The resolution of the sensing pixels in the sensing area of the light sensing device is higher than the resolution of the image pixel of the signal light, such that the data of each image pixel can be restored correctly. That is, when reading data, the light sensing device will set a decoding unit which is formed by a plurality of sensing pixels and the size of the decoding unit is larger than that of a single image pixel. For example, the decoding unit is an area formed by 4×4 sensing pixels. Next, the light sensing device analyzes and processes the sensing data of the 16 sensing pixels so as to restore the data of an image covered by the decoding unit. Normally, the larger the decoding unit is, the more accurate the decoding process will be, meanwhile, the decoding speed is affected and the reading speed is slow. However, when the decoding unit becomes smaller, the image pixels in the vicinity of the to-be-processed image pixel produce more noise effect. And the reading quality is not good due to the noise effect. Therefore, how to take both reading speed and reading quality into account has become an imminent issue to be achieved.

### SUMMARY OF THE INVENTION

The invention is directed to a data reading method for the reading device to appropriately adjust the size of the decoding unit when the reading device is reading a hologram storage medium, such that both reading speed and reading quality are taken into account.

According to a first aspect of the present invention, a data reading method used in a reading device is provided. The reading device is for reading a hologram storage medium having a plurality of data pages, wherein each data page forms a data image having a plurality of image pixels on a sensing area of the reading device. The sensing area has a plurality of sensing pixels. The data reading method first determines a relative positional relationship between each image pixel and the sensing pixels or the optical quality of the corresponding data image of each image pixel. Next, a corresponding decoding unit of the sensing area is determined according to at least one of the relative positional relationship and the optical quality. Last, each image pixel is decoded by the corresponding decoding unit.

The invention will become apparent from the following detailed description of the preferred but non-limiting embodiments. The following description is made with reference to the accompanying drawings.

### BRIEF DESCRIPTION OF THE DRAWINGS

FIG. 1 is a partial diagram of a sensing area of the reading device;

FIGS. 2A˜2H are diagrams of respective decoding unit corresponding to the image pixel p2(l);

FIG. 3 is a data reading method according to a first embodiment of the invention;

FIGS. 4A and 4B are two diagrams of an image pixel and a sensing pixel; and

FIG. 5 is a data reading method according to a second embodiment of the invention.

### DETAILED DESCRIPTION OF THE INVENTION

Some terminologies used in the specification and the appended claims refer to specific elements. Any one who is skilled in related fields will understand that hardware manufacturers may refer to the same element by different names. However, in the present specification and appended claims, elements are differentiated by the functions rather than by names. The term “comprise” is used in the specification and the appended claims in an open manner, and should be interpreted as “comprise but is not limited to”. Besides, the term “coupled to” refers to any direct or indirect way of electrical connection. Thus, the statement “a first device is coupled to a second device” implies the first device is electrically connected to the second device directly or the first device is electrically connected to the second device indirectly through other devices or connecting means.

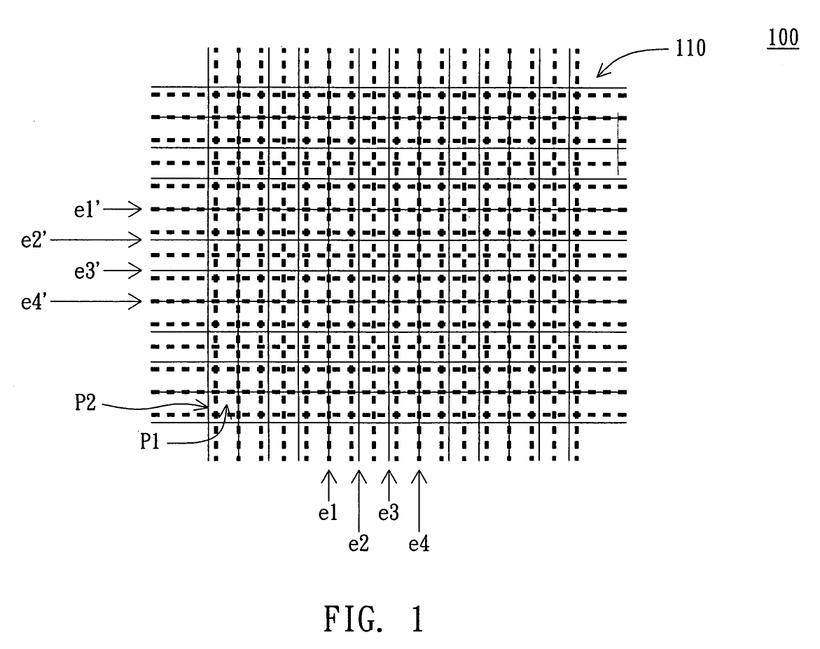

Referring to FIG. 1, a partial diagram of a sensing area of the reading device is shown. In FIG. 1, the data image constructed by a certain data page of a hologram storage medium (not illustrated) is displayed on a sensing area 110 of a reading device 100. The sensing area 110 has a plurality of sensing pixels p1 (denoted in dotted boxes), and the data image has a plurality of image pixels p2 (denoted in solid boxes).

The size of the sensing pixel p1 is smaller than that of the image pixels p2. For example, in FIG.1, the ratio of the side of the image pixel p2 vs. the side of the sensing pixel p1 is 4:3. Meanwhile, the relative positional relationship between different image pixels p2 and the sensing pixels p1 may differ as well. If the relative positional relationship between the image pixel p2(1) (defined by the edges e2, e3, e2′ and e3′ of the image pixel) and the sensing pixels p1 is defined as having 0 horizontal shift and 0 vertical shift, then the relative positional relationship between the image pixel p2(2), which is positioned to the left of the image pixel p2(1), and the sensing pixels p1 has a horizontal shift of +⅓ (and a vertical shift of 0). In other words, with respect to the image pixel p2(2), the sensing pixels p1 is moved to the right by a distance of ⅓ of the side of the sensing pixels p1. Similarly, the relative positional relationship between the image pixel p2(3), which is positioned to the upper right of the image pixel p2(1), and the sensing pixels p1 has a horizontal shift of −⅓ and a vertical shift of −⅓. Thus, the relative positional relationship between each image pixel p2 and the sensing pixels p1 is defined, and the horizontal shift or the vertical shift has a maximum of +½ according to the symmetric relationship of the image pixels.

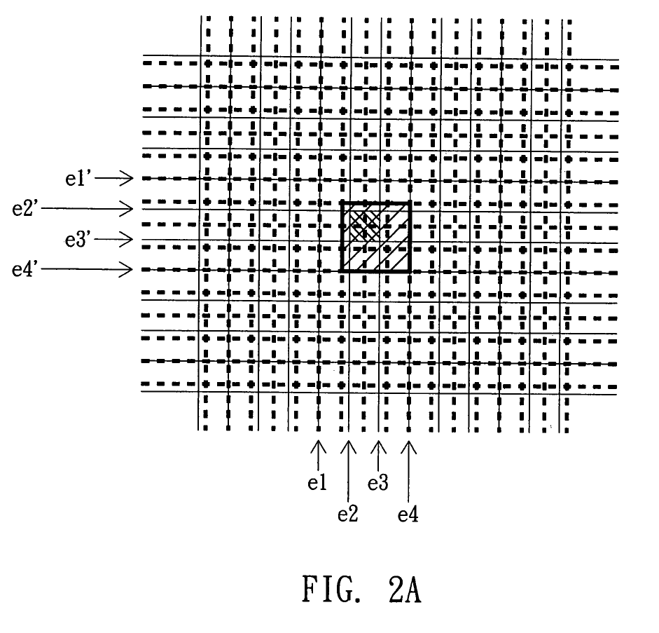

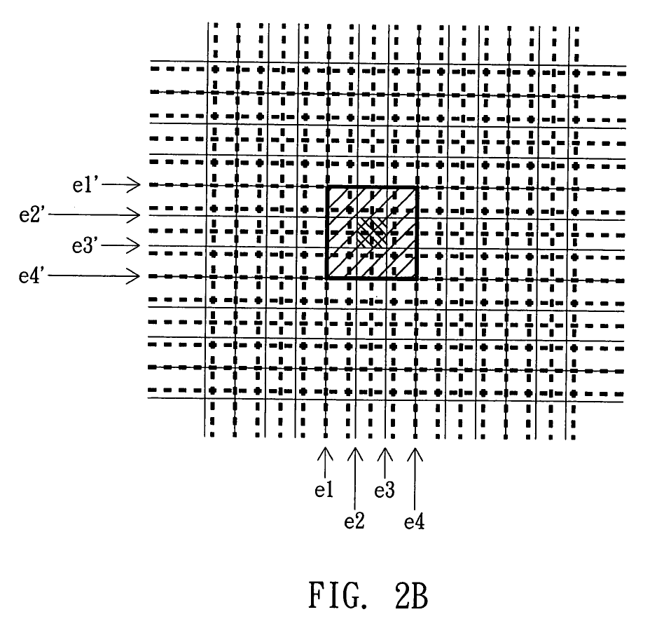

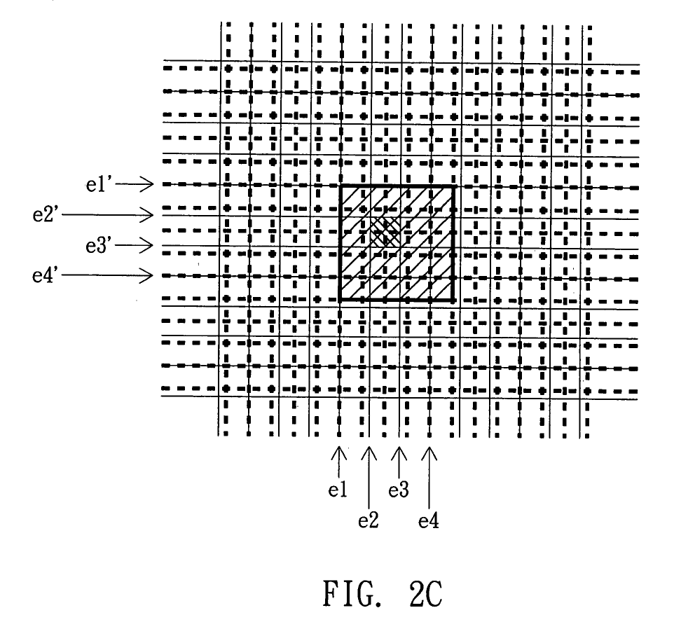

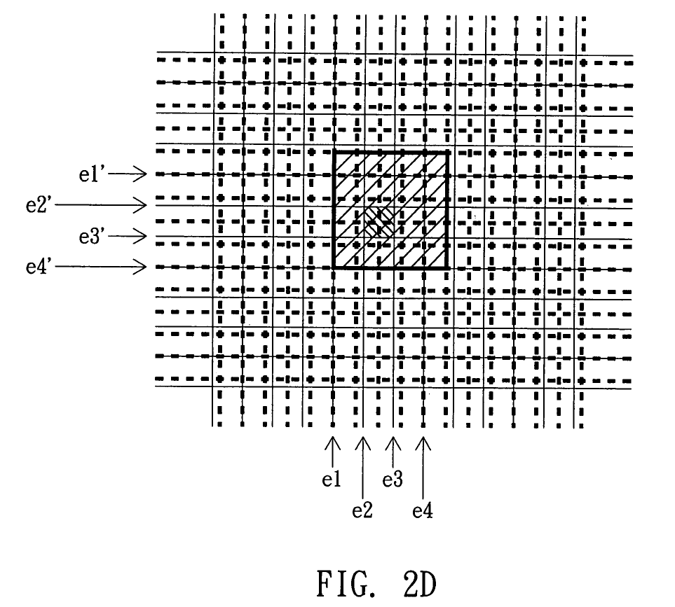

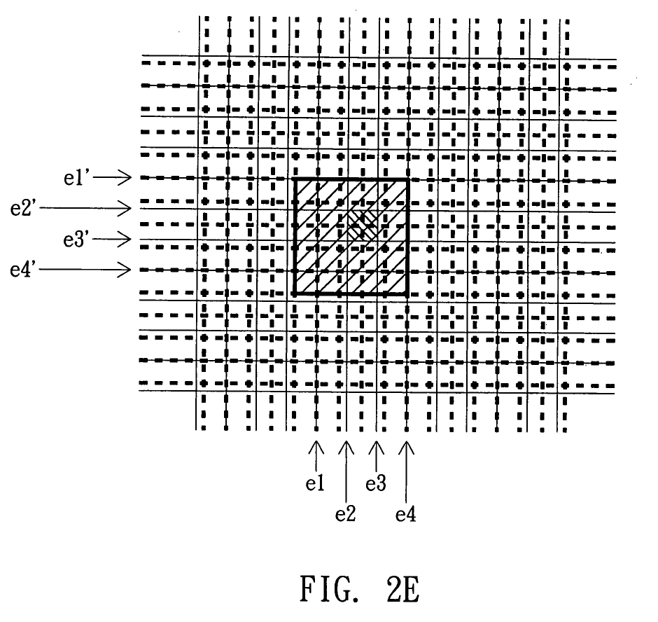

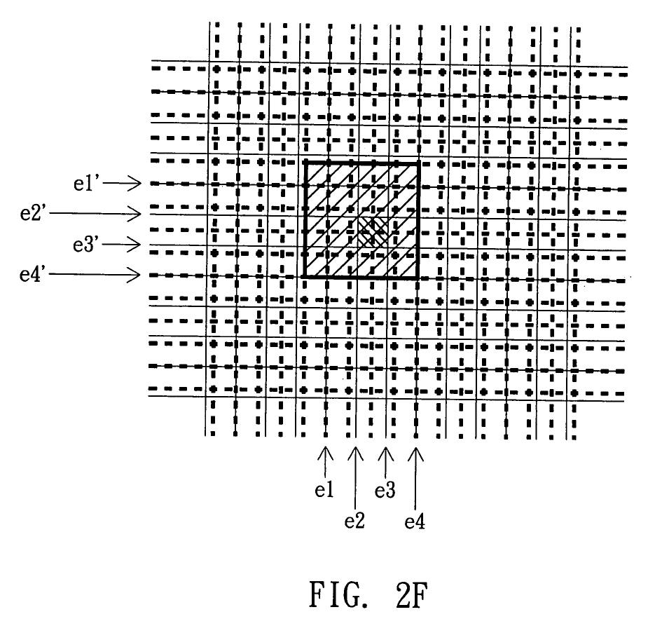

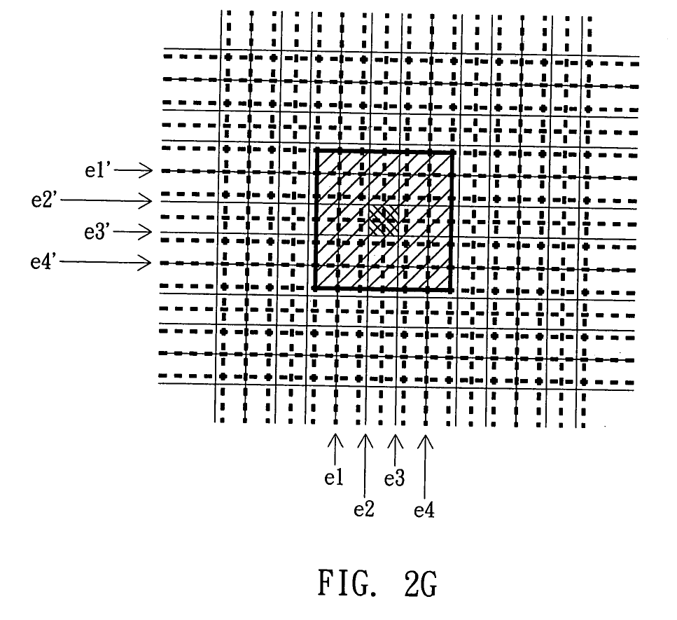

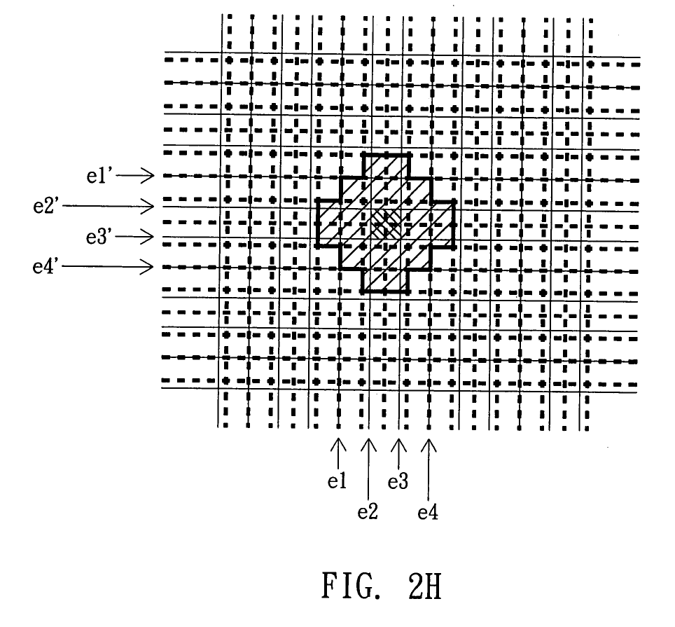

Referring to FIGS. 2A˜2H, diagrams of respective decoding unit corresponding to the image pixel p2(1) are shown. The reading device 100 decodes the image pixel p2(1) by the decoding unit (area in slashes) of various shapes and sizes illustrated in FIGS. 2A˜2H according to hardware specification or quality requirement. Similarly, the image pixel p2(3) or other image pixels whose relative positional relationships are different from the image pixel p2(1) can use various decoding units Illustrated in FIGS. 2A˜2H. The decoding quality for different decoding units is summarized in Table 1 below.

TABLE 1

| | Horizontal Shift Or | | | | | | |
|---|---|---|---|---|---|---|---|
| | Vertical Shift | | | | | | |
| | −½ | − 5/12 | −⅓ | −¼ | −⅙ | − 1/12 | 0 |
| 2A | 18.829 | 18.645 | 17.433 | 15.297 | 13.293 | 11.686 | 10.546 |
| 2B | 19.493 | 20.178 | 19.322 | 17.411 | 15.694 | 14.521 | 14.131 |
| 2C | 20.279 | 20.312 | 19.293 | 17.639 | 16.267 | 15.214 | 14.841 |
| 2D | 20.447 | 20.745 | 19.495 | 17.603 | 16.145 | 15.121 | 14.834 |
| 2E | 20.477 | 20.726 | 19.511 | 17.657 | 16.158 | 15.118 | 14.846 |
| 2F | 20.434 | 21.091 | 19.701 | 17.603 | 16.088 | 15.04 | 14.869 |
| 2G | 21.664 | 21.337 | 19.509 | 17.702 | 16.338 | 15.303 | 15.034 |
| 2H | 21.713 | 21.35 | 19.684 | 17.727 | 16.185 | 15.024 | 14.736 |

Table 1 lists the signal-to-noise ratio (SNR) when the image pixels p2 are decoded by the decoding units illustrated in FIGS. 2A˜2H. When the image pixel p2(1), which has 0 horizontal shif and 0 vertical shift, is decoded by the decoding units of FIGS. 2A˜2H, the SNR ranges between 10.546˜14.736. When the image pixel p2(3), which has horizontal or vertal shift of —⅓, is decoded by the decoding units of FIGS. 2A˜2H, the SNR ranges between 17.433˜19.684. As indicated in Table 1, when the same decoding unit is used, the image pixel having a smaller relative positional shift (horizontal or vertical shift) normally results in a worse decoding quality (the influence of the noise of adjacent image pixels is greater). As for the horizontal or vertical shift other than 0 and −⅓, the decoding quality is affected by the resolution in a part of the data image affected by assembly process or optical error. However, any one who is skilled in the technology of the invention will understand the affection, and the explanation is not repeated here.

Conventionally, each image pixel p2 of the data image is decoded by a fixed decoding unit. If the decoding unit of FIG. 2A is used as the fixed decoding unit, the decoding speed is fast, but the SNR of the image pixel p2(1) is too low (the decoding quality is not good). If the decoding unit of FIG. 2H is used as the fixed decoding unit, the decoding quality is better, but the load to the hardware increases, and the decoding speed for the image pixel p2(3) and the image pixels having larger relative positional shift will decrease.

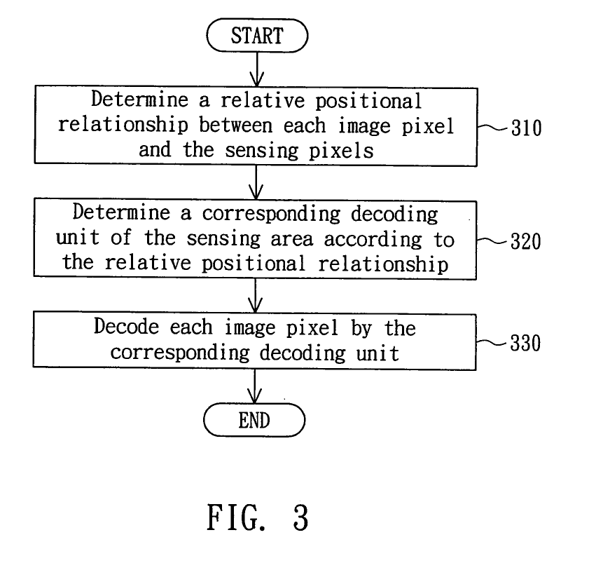

Referring to FIG. 3, a data reading method according to a first embodiment of the invention is shown. First, in step 310, a relative positional relationship between each image pixel and the sensing pixels is determined. Before each image pixel is decoded by a decoding unit, the reading device 100 normally has to perform positioning compensation on the data image. The positioning compensation can be achieved by searching a plurality of reserved block patterns of the data image. Let FIG. 1 be taken for example, the reading device 100 will obtain the relative positional relationship (the horizontal shift and the vertical shift) between each image pixel p2 and the sensing pixels p1.

Next, in step 320, a corresponding decoding unit of the sensing area is determined according to the relative positional relationship. Referring to Table 1, if the standard value of SNR is 15, then the image pixel (such as p2(1)) whose horizontal shift or vertical shift is 0 can be decoded by the decoding unit of FIG. 2G. The image pixel whose horizontal shift or vertical shift is − 1/12 can be decoded by the decoding unit of FIG. 2H. The image pixel whose horizontal shift or vertical shift is −⅙ can be decoded by the decoding unit of FIG. 2B. And the image pixel (such as p2(3)) whose horizontal shift or vertical shift is −⅓˜−½ can be decoded by the decoding unit of FIG. 2A.

Last, in step 330, each image pixel is decoded by a corresponding decoding unit. As disclosed above, different image pixels p2 of the data image are decoded by different decoding units having different numbers of sensing pixels according to the relative positional relationship between each image pixel p2 and the sensing pixels p1. Therefore, the overall decoding speed of the data image will not decrease much but the overall decoding quality is improved up to the desired standard. Thus, if the reading device 100 adopts the above reading method for restoring the data image, both reading speed and reading quality are taken into consideration.

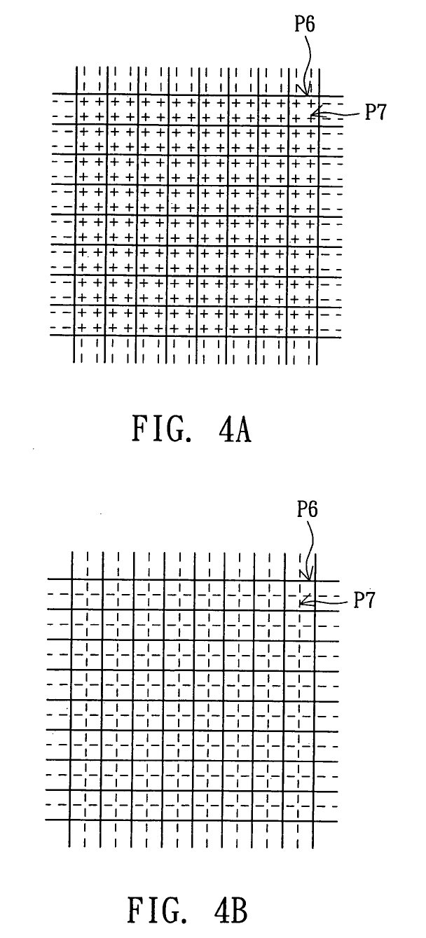

The horizontal shift or the vertical shift is defined according to the ratio of the side of the image pixel and the sensing pixel. FIG. 4A and 4B are two diagrams of an image pixel and a sensing pixel. For example, if the ratio of the side of the image pixel (denoted in solid box) vs. the side of the sensing pixel (denoted in dotted box) be 2:1. The horizontal shift or the vertical shift between the image pixel p6 and the sensing pixels p7 of FIG. 4A are both 0, and the horizontal shift and the vertical shift between the image pixel p6 and the sensing pixels p7 of FIG. 4B are both −½. The relative positional shift ranging from 0 to ±½ can be obtained according to the above definition.

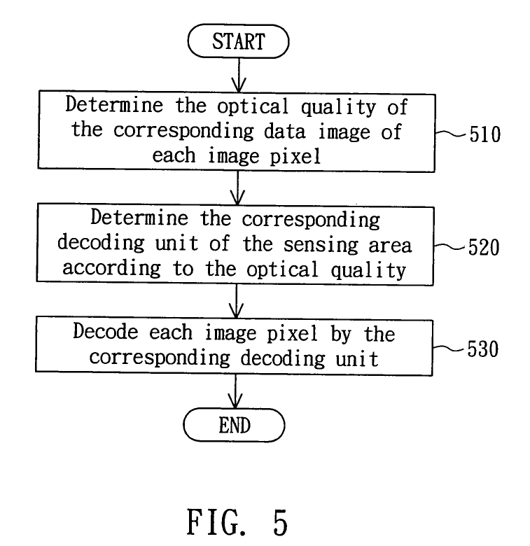

Referring to FIG. 5, a data reading method according to a second embodiment of the invention is shown. The present embodiment differs from the first embodiment in step 510 that determining the optical quality of the corresponding data image of each image pixel. The luminance of a plurality of reserved block patterns of the data image can be used as a standard of the optical quality of the data image. Normally, when the reading device 100 reads different data images, the image pixels of the data image having better optical quality has higher SNR during decoding process (based on the same relative positional relationship and the decoding unit).

Next, in step 520, the corresponding decoding unit of the sensing area is determined according to the optical quality. For example, the image pixel p2(1) of FIG. 1 is decoded by the decoding unit of FIG. 2G. When another image pixel, having 0 horizontal shift and 0 vertical shift, of the data image having better optical quality is decoded by a decoding unit having a smaller amount of sensing pixels, the same SNR value of decoding the image pixel p2(1) still can be achieved. Thus, the reading device 100 takes into account the balance of reading speed and reading quality between different data images.

According to the data reading method disclosed in the above embodiments of the invention, the size of the decoding unit is appropriately adjusted according to at least one of a relative positional relationship between the to-be-processed image pixel and the sensing pixel and an optical quality of the data image, such that the reading device gives consideration to the balance of reading speed and reading quality.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data reading method used in a reading device for reading a hologram storage medium having a plurality of data pages, wherein each data page forms a data image having a plurality of image pixels on a sensing area of the reading device, the sensing area has a plurality of sensing pixels, the method comprises:
(a) determining a relative positional relationship between each image pixel and the sensing pixels or determining an optical quality of the corresponding data image of each image pixel;
(b) determining a corresponding decoding unit of the sensing area according to at least one of the relative positional relationship and the optical quality; and
(c) decoding each image pixel by the corresponding decoding unit.

2. The method according to claim 1, wherein in the step (a), the relative positional relationship at least comprises a horizontal shift and a vertical shift.

3. The method according to claim 2, wherein in the step (a), the horizontal shift between a first image pixel and the sensing pixels is smaller than the horizontal shift between a second image pixel and the sensing pixels, and in the step (b), the number of sensing pixels contained in the corresponding decoding unit of the first image pixel is larger than the number of sensing pixels contained in the corresponding decoding unit of the second image pixel.

4. The method according to claim 1, wherein each data image has at least one reserved block pattern, and in the step (a), the optical quality is the luminance of the reserved block pattern.

5. The method according to claim 4, wherein in the step (a), the luminance of the corresponding reserved block pattern of a first data page is higher than the luminance of the corresponding reserved block pattern of a second data page, and in the step (b), the number of sensing pixels contained in the corresponding decoding unit of a first image pixel of the first data pages is smaller than the number of sensing pixels contained in the corresponding decoding unit of a second image pixel of the second data pages.

6. The method according to claim 5, wherein the relative positional relationship between the first image pixel and the sensing pixels is substantially equal to the relative positional relationship between the second image pixel and the sensing pixels.
